(19) United States
(12) Patent Application Publication
(10) Pub. No.: US 2025/0049071 A1
(43) Pub. Date: Feb. 13, 2025

(54) PROTEIN PREPARATION PRODUCED FROM LINSEED AND PREPARATION METHOD

(71) Applicant: Fraunhofer-Gesellschaft zur Förderung der angewandten Forschung e.V., München (DE)

(72) Inventors: Peter EISNER, Freising (DE); Andreas STÄBLER, Freising (DE); Stephanie MITTERMAIER, Freising (DE); Isabel MURANYI, Freising (DE); Dominic WIMMER, Freising (DE); Klaus SCHREIBER, Freising (DE)

(73) Assignee: Fraunhofer-Gesellschaft zur Förderung der angewandten Forschung e.V., München (DE)

(21) Appl. No.: 18/717,590

(22) PCT Filed: Dec. 9, 2022
(86) PCT No.: PCT/EP2022/085120

§ 371 Date: Jun. 10, 2024

(30) Foreign Application Priority Data
Dec. 10, 2021 (DE) 10 2021 132 628.1

(51) Int. Cl. A23J 1/14; A23J 3/14; A23K 10/30; A23K 20/147

(52) U.S. Cl. CPC A23J 1/142; A23J 3/14; A23K 10/30; A23K 20/147

(57) ABSTRACT

The present invention relates to a protein preparation of linseed and a cost-effective process for its production thereof. The protein preparation has a protein content of more than 30% by mass, an oil content of less than 68 by mass, a content of cyanogenic glycosides of less than 200 mg/kg and a brightness L* of greater than 75. The protein preparation is neutral in taste, light in color and of high quality, so that it is suitable for color and taste demanding food applications such as emulsions and baked goods.

### FIELD OF APPLICATION

The invention relates to a sensorially appealing protein preparation for food, pet food and animal feed produced from linseed and to a method for obtaining such linseed protein ingredients.

### PRIOR ART

Against the backdrop of increasingly scarce agricultural land and other resources, plant-based protein preparations are becoming more and more important for human nutrition and for use in animal feed. The increasing demand for high-quality food is leading to a growing need for nutritionally and techno-functionally optimised protein preparations that can be supplied easily and cost-effectively.

A cost-effective source of proteins for use in food, animal feed and pet food are press and extraction residues from the process of obtaining edible oil from linseed. These press cakes contain a high proportion of protein, which makes them fundamentally interesting for use as a source of protein.

However, linseed press cakes also contain cyanogenic glycosides such as linustatin and neolinustatin, which can be metabolised into hydrocyanic acid and may have a toxic effect in humans. Flaxseed also contains polysaccharides which, when dissolved in water, contribute to a significant increase in viscosity, making aqueous separation processes very difficult. For this reason, aqueous extraction processes are not suitable for obtaining protein isolates from linseed (see, e.g., Mueller, Eisner, Kirchhoff (2010), “Simplified fractionation process for linseed meal by alkaline extraction-Functional properties of protein and fibre fractions”, Journal of Food Engineering, 99, 49-55).

The utilisation of extraction residues (grist) or press cake (flour) from linseed oil extraction for use as feed for livestock is known. Use in foodstuffs has also been described. However, due to the high levels of cyanogenic glycosides in linseed grist or flour, their use is considerably limited. In addition, linseed grist and flour are in most cases very dark in colour, which is undesirable for use in food. Grists and flours made from brown and yellow linseed varieties also have a very intense flavour. The food industry therefore avoids the use of grists and flours from linseed oil production.

Processes for reducing the cyanogenic glycosides in linseed or linseed meal by means of enzymatic, thermal or enzymatic-thermal processes using microwaves, autoclaves, steam treatment or by pelletising are known. It has been shown that the content of cyanogenic glycosides can be reduced to a very large extent under high temperature-time stress. However, thermal treatment also leads to a darker colour of the press cake. In addition, the thermal damage to the proteins associated with the required high temperature-time stress reduces their solubility and functionality. This means that sensory appealing and functional food ingredients with a light colour cannot be produced under such harsh thermal conditions.

Furthermore, various solvent treatments have been described to deplete various secondary plant substances and also the cyanogenic glycosides. It has been shown that mixtures of ethanol or methanol and water with a water content of around 25 to 50% can lead to a depletion of the cyanogenic glycosides. However, the mucilage dissolved in the process and the associated increase in viscosity make the process difficult to realise, as the positive viscosity-increasing effect of the extracted flour (raffinate) is lost and the mass of the raffinate is also reduced. In addition, processing the water-alcohol mixture becomes almost impossible due to the high viscosity. Extractive processes with a high proportion of water in the solvent for the reduction of cyanogenic glycosides have therefore also not been used to date.

Flours are also available with a fat content greater than 6% by mass and an only slightly reduced content of cyanogenic glycosides. However, these preparations form very high concentrations of lipid degradation products within a short time due to the linseed oil they contain, which leads to an unpleasant taste and odour, so that these preparations are also not used in the industry.

As a result, there are currently no neutral-tasting preparations made from linseed oil extraction residues with a low content of cyanogenic glycosides, a light colour and very good technofunctional properties.

### Object of the Present Invention

The object of the present invention was to provide a neutral-flavoured, light-coloured and high-quality protein preparation from linseed and a simple and cost-effective method for preparing it, which is suitable for food applications with a sophisticated taste such as emulsions and baked goods and has a reduced content of cyanogenic glycosides.

### DESCRIPTION OF THE INVENTION

The problem is solved with the protein preparation according to claim 1 and the method for its preparation according to claim 13. Advantageous embodiments of the method and of the protein preparation can be found in the dependent claims and in the following description and the practical example.

The preparation according to the invention can be advantageously obtained by the method according to the invention and is characterised by the following properties (the methods of determination are listed at the end of the description, fat and oil are used synonymously in the following):
The preparation contains proportions of the following components of linseed, advantageously from yellow- or golden-skinned linseed or mixtures of different varieties: oil, husk, mucilage, cyanogenic glycosides and proteins.
The oil content is less than 6% by mass, advantageously less than 4% by mass, better less than 3% by mass, particularly advantageously less than 2% by mass, in each case in relation to the dry mass or dry substance (DM) of the preparation.
The particle size of the preparation advantageously has a d₉₀ value of less than 500 μm, better less than 250 μm, advantageously less than 150 μm, particularly advantageously less than 100 μm.
The L* value of the preparation after grinding to an average particle size d₉₀ (d₉₀: proportion of 90% of the mass of all particles smaller than the specified value) below 250 μm is greater than 75, advantageously greater than 80, better greater than 85, particularly advantageously greater than 90.
The content of cyanogenic glycosides, indicated as HCN per kg of preparation, is less than 200 mg/kg, advantageously less than 100 mg/kg, better less than 50 mg/kg, particularly advantageously less than 30 mg/kg.
The protein content of the preparation is greater than 30 mass percent, advantageously greater than 38% by mass, better greater than 40% by mass, particularly advantageously greater than 45% by mass (factor 6.25 and in relation to DM).
The preparation has good technofunctional properties, the emulsifying capacity is in particular greater than 250 mL/g, advantageously greater than 300 mL/g, better greater than 400 mL/g, particularly advantageously greater than 500 mL/g. The preparation has in particular a (protein) solubility in water at pH 7 of greater than 10%, better greater than 20%, advantageously greater than 30%, advantageously greater than 40%, particularly advantageously greater than 45%.
Optionally and advantageously, the preparation contains proportions of alcohol, in particular ethanol, greater than 0.001% by mass, better >0.01% by mass, advantageously >0.1% by mass, particularly advantageously >0.4% by mass, but in each case less than 1% by mass. This shows that, despite the protein-denaturing properties of the alcohol, the functional properties of the preparation are at a very high level even at a content of 0.4% by mass.
Optionally, the preparation contains proportions of hexane greater than 0.0005% by mass, better >0.001% by mass, but in each case less than 0.005% by mass. Preparations with such hexane contents show better functional properties compared to preparations with lower hexane contents.

The values given in % by mass for the properties of the preparation in the present patent application refer in each case to the dry mass or dry substance of the protein preparation, with the exception of the proportions of solvents, which are given as absolute % by mass.

Surprisingly, preparations containing organic solvents still show very good properties in terms of technofunctionality at the solvent contents indicated, e.g. very good stabilising properties in emulsions and/or beverages, even when used in quantities below 1% by mass.

The inventors were also able to show that preparations extracted with ethanol have a very low bacterial load, advantageously less than 1000 colony-forming units (cfu) per gram of preparation, advantageously less than 100 cfu, particularly advantageously less than 10 cfu per gram, and still have very good functional properties. This is not possible with other preparations whose germ load has not been reduced by ethanol but by means of thermal processes.

In an advantageous embodiment, the preparation has additional ingredients that can be of great benefit in food applications, e.g. for increasing viscosity. For example, the content of the polysaccharides (mucilage) originally contained in the seed husks can be largely retained if the preparation is produced appropriately. In terms of the ratio of mucilage in the seed to protein content in the seed, the ratio of mucilage in the preparation to protein in the preparation is very similar to that in untreated linseed.

Description of the method for preparing the protein preparation:

The method according to the invention has several sub-steps, wherein cleaned linseed is provided and then processed with the husk. This linseed is-optionally after pre-crushing by means of a grinder or roller mill-fed to a mechanical de-oiling process, preferably with a continuous or quasi-continuous press, such as a screw press or an extruder, and freed from oil. The resulting press cakes are then largely freed of oil and some of the water-soluble mono- and disaccharides, in particular sucrose, but only small amounts of water-soluble mucilage, by means of solvent extraction, preferably after setting a defined particle size and a defined water content of the press cake. The solvent is then separated from the preparation (raffinate). Finally, the preparation is preferably ground to a defined particle size distribution. The process can advantageously be accompanied by sieving and screening processes. The process is described in detail below:

### Cleaning:

In a first step, cleaned linseed is provided or linseed is freed from impurities or contaminants by means of mechanical processes. The proportion of impurities is reduced to less than 0.5% by mass, advantageously less than 0.2% by mass, preferably less than 0.1% by mass, particularly advantageously less than 0.05% by mass, or linseed with a correspondingly low proportion of impurities is provided.

### Conditioning or Provision of Suitable Raw Materials:

In an advantageous embodiment, the seed is conditioned by crushing or flaking and/or by heating and/or moisture adjustment prior to mechanical partial de-oiling.

For this purpose, the water content in the seed is adjusted to values between 2 and 8% by mass, preferably between 3 and 6% by mass, particularly advantageously between 4 and 5.5% by mass, or seed is used which has such a water content. Before mechanical partial de-oiling, the seed is advantageously coarsely crushed, e.g. in an impact or cutting mill, to an edge length of 0.5 to 2 mm, advantageously between 0.5 and 1 mm, or the seed is flaked in a roller mill to a flake thickness of less than 1 mm, advantageously less than 0.5 mm.

It is also advantageous to heat the seed to a temperature greater than 40° C. before or after crushing and before mechanical partial de-oiling, advantageously greater than 50° C., preferably greater than 60° C., particularly advantageously greater than 70° C. but less than 100° C. After this type of conditioning, the linseed can be processed particularly well in a continuous press.

### Mechanical Partial De-Oiling:

The oil is separated mechanically from the linseed, which may have been preconditioned, preferably using continuous devices for de-oiling. In the particularly advantageous pressing of the seed to form press cake and oil by means of screw presses or extruders, the pressing is carried out in such a way that the residual oil content after pressing is greater than 8% by mass but less than 30% by mass, advantageously the residual oil content is between 8 and 25% by mass, better between 8 and 20% by mass and particularly advantageously between 8 and 15% by mass. These values also apply if no pressing but other types of mechanical partial de-oiling are used. The lower limit of 8% by mass residual oil content was found to be limited because further oil separation requires significantly higher shear rates, pressing pressures and temperatures, which can contribute to damage to the proteins and a dark colour of the preparations.

In order to prevent the proteins from being damaged too much by the mechanical partial de-oiling, the mechanical partial de-oiling is carried out at moderate temperatures in accordance with the invention. Advantageously, the linseed is pressed or mechanically partially de-oiled at an average temperature below 100° C., particularly advantageously at less than 80° C. The mean temperature is understood to be the arithmetic mean of the temperature of the seed in the feed and the temperature of the press cake or the partially de-oiled linseed at the outlet of the press or the device for mechanical partial de-oiling. This enables gentle pressing of the oil without having to accept significant colour changes or oxidation in the preparation.

### Optional Conditioning of the Press Cake or the Partially De-Oiled Linseed:

Before further processing to separate the residual oil and to reduce the proportion of sucrose from the press cake or partially de-oiled linseed, the press cake or partially de-oiled linseed can, in an advantageous embodiment of the process according to the invention, be conditioned again before extraction. It is shown that reducing the moisture content in the press cake or partially de-oiled linseed to a residual moisture content of less than 8% by mass, advantageously less than 5% by mass, better less than 3% by mass, particularly advantageously less than 2% by mass, e.g. with the aid of dryers, makes de-oiling by means of organic solvents in the subsequent step more efficient and also contributes to better functional properties of the preparations.

It is also advantageous to change the particle size and shape of the press cake or partially de-oiled linseed before or during extraction. This is particularly relevant as press cakes made from linseed tend to form very solid structures, making it difficult or impossible for organic solvents to penetrate. It has been shown that comminution of the press cake or the partially de-oiled linseed to particle sizes with a d₉₀ value of less than 2 mm, preferably less than 1 mm, better less than 0.5 mm, particularly preferably less than 0.2 mm, significantly accelerates extraction. The resulting shorter treatment time leads to an improvement in the functional properties of the preparations, as the residence time in the dryer before extraction and the contact time between solvent and proteins can be reduced. According to the invention, the proportion of fines with a particle size of less than 100 μm in the comminuted press cake or linseed bulk should be less than 50% by mass, advantageously less than 25% by mass, particularly advantageously less than 10% by mass.

It is also possible and advantageous for percolation extraction if the press cake or the partially de-oiled linseed is not ground but flocculated. Advantageously, the flake thickness is set to less than 2 mm, advantageously less than 0.5 mm, particularly advantageously less than 0.2 mm. The term “flake thickness” refers to the average thickness of the material emerging from the roller mill or another flocculation unit. The average thickness can be determined, for example, by measuring with a caliper gauge or a micrometre screw; it then corresponds to the average value from 50 measurements.

The particle size and shape of the press cake during mechanical partial de-oiling with a press can be adjusted using different methods. For example, mills or crushers with corresponding screen inserts or roller mills with defined roller spacings can be used. Particle size distributions with a defined size spectrum can be obtained. These can be equalised after or during grinding by separating them according to size, e.g. by sieving with regard to the particle size distribution.

Comminution in a suspension is particularly advantageous when immersion extraction is used. This means that fast-flowing liquids can also be used as liquid jets or suspensions containing solids to comminute the press cake particles. In addition to liquid nozzles, conveying units, agitators, pumps or mixers, which lead to a shear load on the press cake in the suspension, can also be used to crush the particles and always create a new surface for the solvent to penetrate. Aggregates that are already used in the process to convey the extraction agent are advantageously utilised for this purpose. This makes it possible to use units for comminution that are actually designed for pumping or stirring, such as centrifugal pumps or other forms of conveying units or agitators that introduce high shear forces into the suspension of press cake and solvent. By means of suitable dwell time in these units or by recirculation, it is possible to adjust the comminution in the aforementioned devices in such a way that the particle size distribution according to the invention is obtained.

### Solvent Extraction:

It can be seen that the solvent treatment step has a major influence on the properties of the linseed preparation, both on the oil content and on technofunctional properties such as protein solubility or emulsifying properties. In addition, the solvent extraction conditions largely determine the ratio of mucilage to proteins in the protein preparation after de-oiling.

For the separation of oil and sucrose as well as cyanogenic compounds from the press cake or partially de-oiled linseed, mixtures of alcohols with water are preferably used as solvents. The treatment with alcohol and the treatment with water are carried out simultaneously in the same extraction step (in the form of an alcohol-water mixture). Hexane can also be used as a solvent in the presence of water. Ethanol, iso-propanol or other alcohols can be used, for example. In order to ensure extensive separation of the oil from the press cake or partially de-oiled linseed, the mass proportion of solvent in relation to the mass proportion of press cake or partially de-oiled linseed should be greater than 1.5, preferably greater than 3, better than 5, even better than 7, particularly preferably greater than 10. In this way, an extensive reduction of the oil to below 2% by mass can be achieved.

When using the organic solvents alcohol or hexane during extraction, it is also advantageous for increasing the protein content in the preparation according to the invention if a proportion of water is present in addition to the organic solvent during extraction. This can be achieved by adding water or by using an organic solvent with a defined water content or by adding water via a moist press cake. The water can be used during the solvent extraction of the oil or only afterwards. If organic solvent and water are used simultaneously and a suitable water content is set, it is possible to both further separate the fat from the press cake or linseed and simultaneously remove a proportion of sucrose as well as polar and amphiphilic secondary plant substances without separating the mucilage. This process with simultaneous separation of oil, secondary plant substances and sucrose enables protein preparations with a high protein content of over 45% by mass to be obtained from linseed while retaining almost all of the valuable mucilage. If the mucilage is retained in the preparation, it is also much easier to recover the solvent for reuse in the process, as the viscosity of the miscella is significantly lower and thus the heat transfer during solvent recovery is improved.

For the extraction according to the invention, the water content in the extraction relative to the organic solvent is selected to be greater than 6% by mass, advantageously greater than 7% by mass, particularly advantageously greater than 8% by mass, even better greater than 10% by mass. Surprisingly, when alcohol, in particular ethanol, is used as a solvent, the sucrose can still be de-oiled and separated even with such high water contents, even if the mucilage remains in the raffinate. If alcohols are used as organic solvents, however, the water content should be less than 14% by mass in order to avoid the oil no longer being sufficiently separated and strong oxidation reactions subsequently occurring in the preparation. The targeted use of aqueous solvents with a clearly defined proportion of water makes it possible to obtain protein preparations with good technofunctional properties, which have a particularly light colour and a very high protein content of more than 40% by mass.

As already mentioned, the water content in the extraction process can be adjusted by providing a water-containing solvent, by adding water to the press cake or the partially de-oiled linseed or to the solvent before or during extraction, or by using press cake or partially de-oiled linseed with a residual moisture content. Combinations of the above measures can also be selected.

When using hexane as an organic solvent, higher water contents can be utilised than when using alcohol. The water content in relation to the hexane used can then be greater than 6% by mass, preferably greater than 10% by mass. It is also possible to raise the water content in the hexane above 14% by mass, but then significant amounts of mucilage are transferred to the solvent.

During the treatment of linseed or press cake from linseed with water-alcohol mixtures, the proteins may be denatured. In order to largely avoid this effect, only a small process window is available for the process according to the invention. This includes not only the specified water content, but also the temperature and the residence time. The temperature of the solvent or the mixture of solvents during extraction will therefore be between 30° C. and 75° C. according to the invention, advantageously between 45° C. and 65° C., particularly advantageously between 50° C. and 65° C. This also applies to the use of hexane. In this temperature range, the selected mixtures of water and organic solvent are able to separate both oil and sucrose from the linseed without simultaneously causing too extensive denaturation of the proteins, which is observed at higher temperatures. The duration of contact between the organic solvent and the press cake or the protein preparation at temperatures above 45° C. in the process according to the invention is between 30 minutes and 12 hours, advantageously between 1 hour and 5 hours, particularly advantageously between 1 and 2 hours.

Conventional percolation extraction can be used for extraction, in which a bulk of press cake particles or particles that have been conditioned in terms of particle size/shape or moisture content is overflowed with the solvent so that oil and sucrose can be discharged into the organic solvent or water. As fine particles are detached from the press cake during this process and can be discharged with the solvent, filtration devices must be provided to prevent clogging of pumps and pipes or product losses. In order to limit this process, it can be advantageous to press the press cake into pellets before extraction, from which significantly fewer fine particles are released during extraction. This can significantly reduce the amount of filtration required.

As a loss of fine particles cannot be completely avoided during percolation extraction, immersion extraction, preferably in a mixing-settling process, for example, offers particular advantages. Multi-stage immersion extraction is particularly advantageous. In this process, the press cakes or the conditioned press cakes are completely immersed in the solvent so that virtually no gas comes into contact with the particles. In an immersion extractor, it is thus possible to comminute the particles simultaneously with the extraction by vigorous mixing with an agitator, as described above. This also makes it possible to achieve a step-by-step comminution of the press cake into different particle sizes in several extraction containers arranged one behind the other.

This can be carried out as follows: Following the first extraction step, the oil-laden solvent and the partially de-oiled press cake are mechanically separated from each other, advantageously by sedimentation. The oil-containing supernatant (miscella) can be separated and distilled and the recovered solvent can be used again for the extraction of press cake particles that have already been extracted once or several times and have a smaller particle size distribution than in the previous extraction. The press cake separated from the solvent (raffinate) can be mixed with fresh solvent and thus de-oiled again. The solvent supernatant from the treatment of a raffinate containing less oil can be used again for the extraction of a raffinate containing more oil in order to reduce the total amount of solvent, and so on. This results in countercurrent extraction with agitated tanks containing different sized particles.

A particular advantage of using sedimentation as a separation step is the possibility of using the sedimentation time to adjust the separation shafts of the solid-liquid separation. Here, following extraction, which is carried out with defined particle sizes, sedimentation takes place in the earth's gravity field up to a defined volume ratio of raffinate and supernatant after stirring is stopped. It makes sense to separate the supernatant from the raffinate, e.g. by suction, when the volume ratio of the supernatant is at least 50%, advantageously greater than 60%, particularly advantageously greater than 70%.

The raffinate can be re-suspended with solvent in the countercurrent and the suspension stirred until a new particle size distribution is achieved due to the shearing during stirring. The sedimentation process then takes place again. The process of mixing and settling the raffinate can be repeated several times, advantageously the process is carried out more than twice, preferably more than three times, particularly advantageously more than four times, so that the multi-stage extraction is carried out particularly advantageously in countercurrent. In one embodiment of the method, it is advantageous to use different mixing ratios of organic solvent and water in different stages of the multi-stage extraction. For example, in the first extraction stage, in which the fresh press cake is used, a higher water content can be utilised in order to specifically separate water-soluble components; in further extraction stages, the water content can be selected to be lower in order to make the separation of oil more efficient, since, for example, a solvent such as ethanol or iso-propanol with a lower water content can dissolve more oil. When using ethanol as a solvent, for example, this procedure also has the advantage that the water content is only high for a short time in the first extraction stage, so that protein denaturation and the co-dissolution of mucilage can be minimised. This change in water content is advantageously supported by the fact that after the second and/or third extraction, part of the supernatant is not used for the subsequent extraction, but is separated off and treated with the miscella. In this way, the discharge of mucilage from the linseed press cake can be kept particularly low by minimising the water content during extraction.

In addition to mixing water and an organic solvent such as ethanol in an extraction step, it can also be advantageous to initially use a lipophilic solvent such as hexane or a less polar solvent such as ethanol with a water content of less than 5% by mass for the first extraction steps and, after partial separation of the solvent or complete desolventisation of the raffinate, to use a solvent with a higher water content. This can further reduce the discharge of mucilage due to a particularly low water content.

### Post-Treatment and Desolventisation of the Preparation:

Following extraction with organic solvents and water, the preparation can optionally, to functional properties, be further treated with aqueous solutions containing proteolytic enzymes or by means of fermentation or dried directly. Drying is advantageously carried out at low temperatures in the product below 120° C., better below 100° C., particularly advantageously below 80° C., in order to preserve the proteins and keep the colour in the preparation as light as possible. A dryer with a jacket temperature above 100° C., better above 120° C., which is operated in a vacuum and whose pressure is lowered again at the end of drying to separate the solvent residues, is advantageously used for this purpose. Advantageously, the pressure is lowered to values of less than 500 mbar, better less than 200 mbar, particularly advantageously less than 100 mbar. This reduction in pressure at the end of the drying process can reduce the temperature during post-drying and thus further protect the proteins.

After drying, the dried protein preparations are advantageously ground to adjust the functionality, as preparations ground to different finenesses show clear differences in the technofunctional properties, such as solubility. Depending on the application, grinding is therefore carried out to d₉₀ particle sizes smaller than 500 μm, advantageously smaller than 250 μm, better smaller than 150 μm, particularly advantageously smaller than 100 μm.

Post-treatment and desolventisation of the miscella: The miscella loaded with oil and water is advantageously separated by distillation and, if necessary, concentrated by rectification. This shows that the mono- and disaccharides and mucilage as well as secondary plant substances accumulate in the water phase. This can then be separated from the oil phase mechanically, e.g. centrifugally or in a gravitational field.

### Description of a Use of the Preparation:

The use of the preparation of linseed according to the invention has particular advantages when protein mixtures are produced with other protein ingredients for food or pet food. Due to the very appealing sensory properties and the increase in viscosity, interfering flavours from other raw materials, such as pea protein in aqueous solutions, can no longer be perceived as intensively, which increases consumer acceptance.

A mixture of the preparation according to the invention with protein portions of legume protein from the group of pea, lentil, bean, field bean, peanut or soya is advantageous, particularly advantageously only from the group of pea and soya, particularly advantageously only pea.

A mixture of the stated proteins and the linseed preparation according to the invention should have >60% by mass, advantageously >70% by mass, particularly advantageously >80% by mass of protein content. The ratio of the protein according to the invention to the total mass of the mixture should be greater than 1% by mass and less than 50% by mass, advantageously greater than 3% by mass and less than 40% by mass, particularly advantageously greater than 5% by mass and less than 20% by mass. The low proportions of the preparation according to the invention make it possible to combine the functionality of the legume proteins with the good sensory properties of the preparation according to the invention without increasing the viscosity of the mixture too much in a water-containing food application.

In the following, the following determination methods are used for the quantitative characterisation of the protein preparations produced:

### Protein Content:

The protein content is defined as the content calculated by determining the nitrogen according to Dumas and multiplying it by a factor of 6.25. The protein content is stated in the present patent application in percent by mass, in relation to the dry matter (DM), i.e. the anhydrous sample.

### Colour:

The perceptible colour is defined by means of CIE-L*a*b* colour measurement. The L* axis indicates the brightness, where black has the value 0 and white the value 100. The a* axis describes the green or red component and the b* axis the blue or yellow component.

### Protein Solubility:

The protein solubility is determined using the determination method according to Morr et al. 1985, see the journal article: Morr C. V., German, B., Kinsella, J. E., Regenstein, J. M., Van Buren, J. P., Kilara, A., Lewis, B. A., Mangino, M. E, “A Collaborative Study to Develop a Standardized Food Protein Solubility Procedure. Journal of Food Science”, volume 50 (1985) pages 1715-1718). The protein solubility can be given for a defined pH value; if no pH value is stated, the data refer to a pH value of 7.

### Emulsifying Capacity:

The emulsifying capacity using the is determined determination method (hereinafter referred to as the EC determination method), in which 100 ml of a 1% suspension of the protein preparation with pH 7, maize germ oil is added until phase inversion of the oil-in-water emulsion. The emulsifying capacity is defined as the maximum oil absorption capacity of this suspension, determined by the spontaneous decrease in conductivity during phase inversion (see the journal article by Wäsche, A., Muller, K., Knauf, U., “New processing of lupin protein isolates and functional properties”. Nahrung/Food, 2001, 45, 393-395) and is expressed, for example, in ml oil/g protein preparation, i.e. millilitres of emulsified oil per gram of protein preparation

Fat Content (Synonymous with Oil Content):

The fat or oil content is determined according to the Soxhlet method using hexane as a solvent.

### Content of Cyanogenic Glycosides as Hydrogen Cyanide (HCN):

Specified as HCN content in mg HCN per kg preparation (in relation to DM), determined by HPLC from the lead substances linustatin and neolinustatin according to Schilcher, H. & Wilkens-Sauter, M. (1986). Quantitative determination of cyanogenic glycosides in Linum usitatissimum by HPLC. Fatty Soaps Coatings, 88, 287-290.

### Sucrose:

The sucrose content is determined by means of modified measurement in accordance with DIN 10758:1997-05 (incl. revision 1 of September 2018) using HPLC methods. For sample preparation, the sugars are extracted from the sample matrix with hot water. After separation of impurities, the extracts are made up to a defined volume with water, filtered and the filtrates are fed to the HPLC measurement.

### Water Binding:

The water binding capacity is determined using the method described in: American Association of Cereal Chemists, “Approved methods of the AACC”. 10th ed., AACC. St. Paul, MN, 2000b; Method 56-20 “Hydration capacity of pregelatinized cereal products”. The water-binding capacity can be expressed, for example, in ml/g, i.e. millilitres of bound water per gram of preparation, and is determined according to the AACC determination method by the weight of the water-saturated sediment minus the weight of the dry preparation after mixing approx. 2 g of protein preparation with approx. 40 ml of water for 10 minutes and centrifugation at 1000 g for 15 minutes at 20° C.

### Oil Binding:

The oil-binding capacity can be expressed in ml/g, i.e. millilitres of bound oil per gram of preparation, and is measured according to the centrifuge determination method as the volume of the oil-binding sediment after mixing 1.5 g of protein preparation with 15 ml of maize germ oil for 1 minute and centrifugation at 700 g for 15 minutes at 20° C.

### Practical Example

1000 g of a linseed press cake with an oil content of 20% by mass, which was obtained by pressing linseed using a press at an average temperature of 75° C., was dried in a dryer to a water moisture content of 2.5% by mass and the press cake was coarsely crushed into pieces with an edge length of less than 1 mm using a cutting mill. The crushed press cake was extracted 6 times with 4000 mL of solvent (ethanol-water mixture with 7% by mass water content). In the first stage, 4000 mL was added to the 1000 g of press cake, stirred for 5 minutes at 62° C. and then the stirrer was switched off. The solid sedimented for 30 minutes, after which 2500 mL of supernatant was removed and another 2500 mL of solvent was added. The following extraction steps were carried out in the same way, with 2500 mL added and 2500 mL removed in each case. The last raffinate or sediment was then dried in a drying oven for 24 hours after separation of the supernatant. It was then ground to less than 250 μm. The preparation had a pleasant linseed flavour, a protein content of 46.4% in relation to the dry matter, a protein solubility of 43.5% at pH 7 and an emulsifying capacity of 593 mL/g. In the L*a*b measurement, an L* value of 82.7 was determined. The proportion of cyanogenic compounds determined as hydrocyanic acid was 32 mg/kg dry matter. Further properties of the preparation obtained can be found in the following tables.

TABLE 1
L*a*b* colour values of the preparation and an
aqueous suspension

| | Colour value | | |
|---|---|---|---|
| Colour values | L* | a* | b* |
| Linseed protein preparation as | 82.7 | 3.3 | 17.8 |
| flour | | | |
| Aqueous suspension with 2% | 83.4 | 4.4 | 29.7 |
| by mass flour | | | |

TABLE 2
Composition of raw materials and preparations

| | | | | | | | Hydrogen |
|---|---|---|---|---|---|---|---|
| | | Ash | Ash | | | | cyanide |
| | DM | (550° C.) | (950° C.) | Protein | Oil | Sucrose | [mg HCN/ |
| Preparation | [%] | [% DM] | [% DM] | [% DM] | [% DM] | [% DM] | kg DM] |
| Linseed protein | 90.9 | 6.2 | 5.7 | 46.4 | 0.9 | <0.5 | 32 |
| preparation, | | | | | | | |
| pressed, with | | | | | | | |
| ethanol-water | | | | | | | |
| mixture | | | | | | | |
| extracted | | | | | | | |
| Linseed protein | 91.5 | 5.7 | 5.3 | 44.5 | 2.6 | 1.5 | 393 |
| preparation, | | | | | | | |
| only with | | | | | | | |
| hexane without | | | | | | | |
| added water | | | | | | | |
| extracted | | | | | | | |
| Linseed before | 94.1 | 3.3 | 3.0 | 25.6 | 42.5 | 1.8 | 234 |
| the treatment | | | | | | | |

TABLE 3
Functional properties of the preparations

| | Protein | | Emulsifying | Minimum gel | Water | Oil |
|---|---|---|---|---|---|---|
| Functional | solubility [%] | | capacity | concentration | binding | binding |
| properties | pH 4.5 | pH 7.0 | [mL/g] | [%] | [mL/g] | [mL/g] |
| Linseed protein | 18.2 | 43.5 | 593 | 10.0 | n.b. | 1.3 |
| preparation, | | | | | | |
| with ethanol- | | | | | | |
| water mixture | | | | | | |
| extracted | | | | | | |

### Practical Example

50 g of the linseed preparation from the practical example was mixed with further protein from pumpkin and wheat flour in a ratio of 1:5:3 to form a dough and baked at 180° C. to make protein biscuits. The appearance was very appealing, the biscuits were firm and crumbly, had an appealing bite and a slightly nutty flavour.

1. A protein preparation, produced from linseed, with a
protein content of more than 30% by mass in relation to the dry matter, and
an oil content of less than 6% by mass in relation to the dry matter, determined by the Soxhlet method using hexane as solvent,
wherein the protein preparation has
a cyanogenic glycoside content of less than 200 mg/kg, expressed as HCN per kg of preparation, and
a brightness L* of greater than 75, determined according to CIE-L*a*b* colour measurement at a d₉₀ particle size of the protein preparation below 250 μm or after grinding the protein preparation to a do particle size below 250 μm.

2. The protein preparation according to claim 1,
which has a brightness L* of greater than 80, preferably greater than 85, particularly preferably greater than 90.

3. The protein preparation according to claim 1,
which has a cyanogenic glycoside content, expressed as HCN per kg of preparation, of less than 100 mg/kg, preferably less than 50 mg/kg, particularly advantageously less than 30 mg/kg.

4. The protein preparation according to claim 1,
in which the protein content is more than 38% by mass, preferably more than 40% by mass, particularly preferably more than 45% by mass.

5. The protein preparation according to claim 1,
in which the oil content is less than 4% by mass, preferably less than 3% by mass, particularly preferably less than 2% by mass.

6. The protein preparation according to claim 1,
in which the emulsifying capacity, determined according to the EC determination method specified in the description, is more than 250 ml/g, preferably more than 300 ml/g, particularly preferably more than 400 ml/g or more than 500 ml/g.

7. The protein preparation according to claim 1,
which has a protein solubility in water at pH 7 of more than 10%, preferably more than 20% or more than 30%, particularly preferably more than 40% or more than 45%.

8. The protein preparation according to claim 1,
which has a proportion of alcohol, in particular ethanol, of >0.001% by mass, preferably >0.01% by mass, particularly preferably >0.1% by mass or >0.4% by mass, but which is less than 1% by mass.

9. The protein preparation according to claim 1, which has a hexane content of >0.0005% by mass, preferably >0.001% by mass, but which is less than 0.005% by mass.

10. The protein preparation according to claim 1, which has a d₉₀ particle size of less than 500 μm, preferably less than 250 μm, advantageously less than 150 μm, particularly preferably less than 100 μm.

11. The protein preparation according to claim 1,
to which legume proteins from the group of pea, lentil, bean, field bean, peanut or soya, preferably only from the group of pea and soya, particularly preferably only from pea, have also been added.

12. Use of the preparation according to claim 1 as an ingredient in foods, pet foods and animal feeds.

13. A method for obtaining a protein preparation from linseed, in particular according to claim 1, comprising at least the following steps:
mechanical partial de-oiling of the linseed;
carrying out one or more extraction steps to further de-oil the partially de-oiled linseed, optionally after grinding or flaking, down to a residual oil content of less than 6% by mass, in which a proportion of sucrose is also separated off,
wherein the one or more extraction steps are carried out with one or more alcohol-water mixtures or with alcohol or hexane as solvent in the presence of water, each with a water content in the range between >6% by mass and <14% by mass for alcohols and between >6% by mass and <14% by mass for hexane, or wherein the multiple extraction steps are carried out with alcohol or hexane as a first solvent and with water as a second solvent; and
drying the raffinate obtained after carrying out one or more extraction steps.

14. The method according to claim 13,
in which the average temperature of the linseed is kept below 100° C., preferably below 80° C., during the mechanical partial de-oiling.

15. The method according to claim 13,
in which further de-oiling of the partially de-oiled linseed is carried out to a residual oil content of less than 4% by mass, preferably less than 3% by mass, particularly preferably less than 2% by mass.

16. The method according to claim 13, in which the one or more extraction steps are carried out with one or more alcohol/water mixtures as solvent or with alcohol as solvent in the presence of water, wherein the water content in each case is in the range between >7% by mass and <14% by mass, preferably between >9% by mass or >10% by mass and <14% by mass.

17. The method according to claim 13, in which the one or more extraction steps are carried out with hexane as solvent in the presence of water, wherein the water content in each case is in the range between >10% by mass and <14% by mass.

18. The method according to claim 13, in which the water content in a multi-stage extraction is chosen to be highest in the first stage and lower in one or more subsequent stages.

19. The method according to claim 13, in which a temperature of the solvent is selected between 30° C. and 75° C., preferably between 45° C. and 65° C., particularly preferably between 50° C. and 65° C., when carrying out the one or more extraction steps.

20. The method according to claim 19,
in which a duration of contact between the solvent and the partially de-oiled, optionally ground or flaked, linseed at temperatures of the solvent of >45° C. is selected between 30 minutes and 12 hours, preferably between 1 hour and 5 hours, particularly preferably between 1 and 2 hours.

21. The method according to claim 13, in which the mechanical partial de-oiling takes place down to a residual oil content of between >8% by mass and <30% by mass, preferably between >8% by mass and <25% by mass, particularly preferably between >8% by mass and <20% by mass or between >8% by mass and <15% by mass.

22. The method according to claim 13, in which the linseed is conditioned prior to mechanical partial de-oiling by adjusting the moisture content of the seed to a water content in the seed of between 2 and 8% by mass, preferably between 3 and 6% by mass, particularly preferably between 4 and 5.5% by mass.

23. The method according to claim 13, in which the linseed is heated to a temperature >40° C., preferably >50° C., advantageously >60° C., particularly preferably >75° C., but <100° C., before the mechanical partial de-oiling.

24. The method according to claim 13, in which the linseed is coarsely crushed to an edge length of between 0.5 and 2 mm, advantageously between 0.5 and 1 mm, or flaked to a flake thickness of less than 1 mm, preferably less than 0.5 mm, prior to the mechanical partial de-oiling.

25. The method according to claim 13, in which the partially de-oiled, optionally coarsely crushed, ground or flaked linseed is conditioned before carrying out the one or more extraction steps by lowering the moisture content to a residual moisture content of <8% by mass, preferably <5% by mass, particularly preferably <3% by mass or <2% by mass.

26. The method according to claim 13, in which a particle size of the partially de-oiled linseed is brought to a d₉₀ value of <2 mm, preferably <1 mm, particularly preferably <0.5 mm or <0.2 mm, before or during the execution of the one or more extraction steps, wherein preferably a proportion of fines with a particle size of less than 100 μm is <50% by mass, particularly preferably <25% by mass or <10% by mass.

27. The method according to claim 13,
in which the partially de-oiled linseed is flaked to a flake thickness of <2 mm, preferably <0.5 mm, particularly preferably <0.2 mm, before the one or more extraction steps are carried out.

28. The method according to claim 13, in which the raffinate is dried at a temperature of <120° C., preferably <100° C., particularly preferably <80° C.

29. The method according to claim 13, in which the raffinate is dried in a vacuum dryer, wherein the pressure is reduced to <500 mbar, preferably <200 mbar, particularly preferably <100 mbar at the end of drying.

30. The method according to claim 13, in which the raffinate is treated with aqueous enzyme solutions or by fermentation before drying.

31. The method according to claim 13, in which the raffinate is ground after drying to a defined particle size distribution with a d₉₀ value of <500 μm, preferably <250 μm, particularly preferably <150 μm or <100 μm.
